(19) United States
(12) Patent Application Publication
(10) Pub. No.: US 2016/0029386 A1
(43) Pub. Date: Jan. 28, 2016

(54) WIRELESS COMMUNICATION DEVICE AND WIRELESS COMMUNICATION SYSTEM

(71) Applicant: Kabushiki Kaisha Toshiba, Tokyo (JP)

(72) Inventor: Masahiro Sekiya, Inagi Tokyo (JP)

(21) Appl. No.: 14/644,359

(22) Filed: Mar. 11, 2015

(30) Foreign Application Priority Data
Jul. 24, 2014 (JP) 2014-151126

(51) Int. Cl. H04W 72/04; H04L 12/863

(52) U.S. Cl. CPC H04W 72/0453; H04L 47/50; H04W 84/12

(57) ABSTRACT

A wireless communication device includes a wireless transmitting/receiving part, a response channel selecting part and an oscillating part. The wireless transmitting/receiving part receives a first frame in which data destined for an address of the wireless communication device and data destined for an address of another wireless communication device are included. The oscillating part outputs a carrier signal having a frequency that corresponds to the response channel selected by the response channel selecting part to the wireless transmitting/receiving part. The response channel selecting part decides an ordinal rank for response channel selection based on the information included in the first frame and selects a response channel that corresponds to the decided ordinal rank The wireless transmitting/receiving part uses the carrier signal to transmit the response frame in the response channel.

### CROSS REFERENCE TO RELATED APPLICATIONS

This application is based upon and claims the benefit of priority from the prior Japanese Patent Application No. 2014-151126, filed on Jul. 24, 2014, the entire contents of which are incorporated herein by reference.

### FIELD

Embodiments described herein relate generally to a wireless communication device and a wireless communication system.

### BACKGROUND

IEEE 802.11ac is one of wireless LAN communication standards. The IEEE 802.11ac standard defines a downlink multi-user multiple input multiple output (DL-MU-MIMO) communication.

In the DL-MU-MIMO communication, a single access point having a plurality of antennas uses a same radio frequency band to transmit data destined for a plurality of wireless terminals spatially multiplexed. The plurality of wireless terminals can simultaneously receive the spatially multiplexed data, that is, stream destined for the respective wireless terminals.

The DL-MU-MIMO communication allows the data throughput of the access point to be improved compared with sequential transmission of data destined for the wireless terminals.

In the DL-MU-MIMO communication, the wireless terminals having received data from the access point transmit a block acknowledgement frame back to the access point. The block acknowledgement frame is a response frame to the data transmitted from the access point. The access point confirms that the data transmitted to the wireless terminals has been received by the wireless terminals, by receiving the block acknowledgement frames from the wireless terminals.

According to prior art, however, the wireless terminals sequentially transmit the block acknowledgement frame to the access point. Therefore, it takes long for the access point to receive the block acknowledgement frames from the wireless terminals, and it is difficult for the access point to achieve efficient communication with the wireless terminals.

In a single-carrier frequency division multiple access (SC-FDMA) scheme, a plurality of wireless terminals can simultaneously transmit a frame in different frequency channels. However, to apply the simultaneous transmission according to the SC-FDMA scheme to the transmission of the block acknowledgement frames, an additional negotiation, such as a frequency scheduling for assigning a frequency band to each wireless terminal, is needed.

Therefore, it is desired to simply improve throughput of wireless LAN communication.

### BRIEF DESCRIPTION OF THE DRAWINGS

FIG. 1 is a schematic diagram showing an example of a configuration of a wireless communication system 3 according to a first embodiment;

FIG. 2 is a block diagram showing an example of a configuration of the wireless communication device 1 according to the first embodiment;

FIG. 3 is a time chart showing an example of an operation of the wireless communication device 1 according to the first embodiment;

FIG. 4 is a diagram for illustrating a MAC frame format defined in IEEE 802.11;

FIG. 5 is a diagram for illustrating a PHY header format of a MU-MIMO frame defined in IEEE 802.11ac;

FIG. 6 is a flowchart showing an example of an operation of the wireless communication device 1 according to the first embodiment;

FIG. 7 is a flowchart showing an example of an operation of the wireless communication device 1 according to the second embodiment;

FIG. 8 is a time chart showing an example of an operation of the wireless communication device 1 according to the third embodiment;

FIGS. 9A to 9C are diagrams for illustrating notification fields, which illustrate an example of a configuration of the wireless communication system 3 according to the fourth embodiment;

FIG. 10 is a time chart showing an example of an operation of the wireless communication system 3 according to the fourth embodiment;

FIG. 11 is a time chart showing an example of an operation of the wireless communication system 3 according to the fifth embodiment; and

FIG. 12 is a time chart showing an example of an operation of the wireless communication system 3 according to the sixth embodiment.

### DETAILED DESCRIPTION

A wireless communication device that performs wireless communication according to an embodiment includes a wireless transmitting/receiving part, a response channel selecting part and an oscillating part. The wireless transmitting/receiving part receives a first frame transmitted from a transmission source in which data destined for an address of the wireless communication device and data destined for an address of another wireless communication device are included. The response channel selecting part selects a response channel used for transmission of a response frame to the transmission source based on information included in the first frame received by the wireless transmitting/receiving part. The oscillating part outputs a carrier signal having a frequency that corresponds to the response channel selected by the response channel selecting part to the wireless transmitting/receiving part. The response channel selecting part decides an ordinal rank for response channel selection based on the information included in the first frame and selects a response channel that corresponds to the decided ordinal rank The wireless transmitting/receiving part uses the carrier signal output from the oscillating part to transmit the response frame in the response channel.

In the following, embodiments of the present invention will be described with reference to the drawings. The embodiments are not intended to limit the present invention.

### First Embodiment

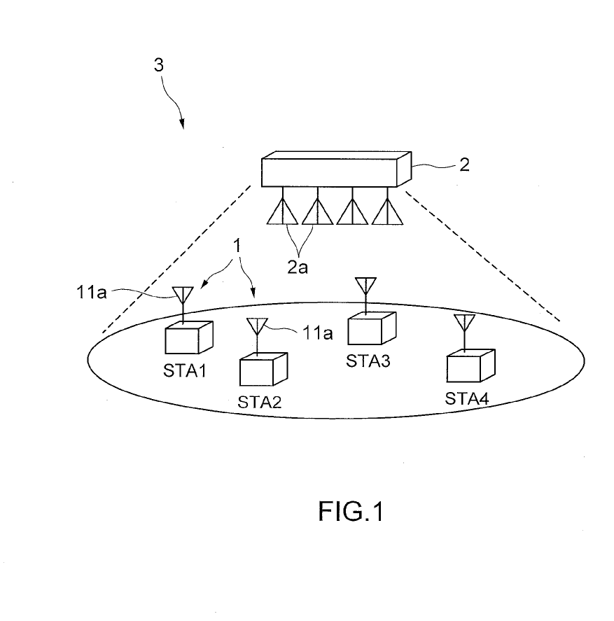

FIG. 1 is a schematic diagram showing an example of a configuration of a wireless communication system 3 according to a first embodiment. As shown in FIG. 1, the wireless communication system 3 includes a plurality of first wireless communication devices 1 and a second wireless communication device 2. The second wireless communication device 2 transmits, to each of the plurality of first wireless communication devices 1, a first frame of spatially multiplexed data destined for an address of the first wireless communication device 1.

The wireless communication system 3 shown in FIG. 1 is a wireless communication system that performs wireless communication according to a wireless LAN communication scheme complying with IEEE 802.11, for example. Note that IEEE 802.11 includes IEEE 802.11a, IEEE 802.11b, IEEE 802.11g, IEEE 802.11n and IEEE 802.11ac, for example (the same holds true for the following description).

As shown in FIG. 1, the plurality of first wireless communication devices 1 are wireless terminals of a wireless LAN, that is, stations “STA1” to “STA4”, and the second wireless communication device 2 is an access point of the wireless LAN, that is, a wireless base station. That is, the wireless communication system 3 shown in FIG. 1 provides a wireless LAN in an infrastructure mode formed by one wireless base station and one or more wireless terminals.

The second wireless communication device 2 shown in FIG. 1 has a plurality of antennas 2a, the number of antennas 2a being equal to or larger than the number of the first wireless communication devices 1. The second wireless communication device 2 transmits the first frame to each first wireless communication device 1 through a corresponding one of the antennas 2a by DL-MU-MIMO communication. In this process, the second wireless communication device 2 transmits the first frame to all the first wireless communication devices 1 in the same frequency band at the same time. The frequency band used for transmission of the first frame is a 2.4 GHz band or a 5 GHz band, for example.

The first wireless communication devices 1 and the second wireless communication device 2 may form a wireless LAN communication network in an ad hoc mode, in which wireless terminals directly communicate with each other without needing any wireless base station. The second wireless communication device 2 may form a network of a wireless distribution system (WDS), in which wireless base stations communicate with each other.

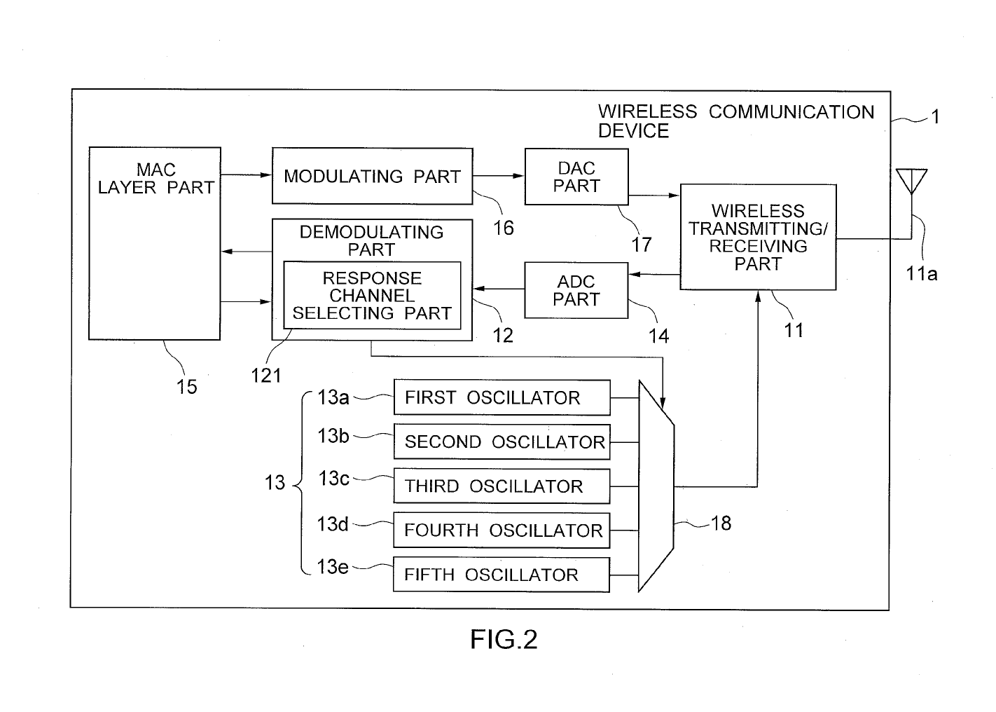

FIG. 2 is a block diagram showing an example of a configuration of the wireless communication device 1 according to the first embodiment.

As shown in FIG. 2, the first wireless communication device 1 includes a wireless transmitting/receiving part 11, a response channel selecting part 121, an oscillating part 13, a demodulating part 12, an analog to digital converter (ADC) part 14, a media access control (MAC) layer part 15, a modulating part 16, a digital to analog converter (DAC) part 17, and a multiplexing part 18.

The wireless transmitting/receiving part 11, the ADC part 14, the demodulating part 12 and the MAC layer part 15 form a receiving system. In the receiving system, the ADC part 14 is disposed in a subsequent stage of the wireless transmitting/receiving part 11, the demodulating part 12 is disposed in a subsequent stage of the ADC part 14, and the MAC layer part 15 is disposed in a subsequent stage of the demodulating part 12.

The MAC layer part 15, the modulating part 16, the DAC part 17 and the wireless transmitting/receiving part 11 form a transmitting system. In the transmitting system, the modulating part 16 is disposed in a subsequent stage of the MAC layer part 15, the DAC part 17 is disposed in a subsequent stage of the modulating part 16, and the wireless transmitting/receiving part 11 is disposed in a subsequent stage of the DAC part 17.

The components 11 to 18 of the first wireless communication device 1 described above may be implemented by analog or digital circuits or software or the like that is executed by an arithmetic processing unit such as a CPU.

As shown in FIG. 2, the wireless transmitting/receiving part 11 has an antenna 11a. At the antenna 11a, the wireless transmitting/receiving part 11 receives the first frame transmitted from the second wireless communication device 2, that is, a transmission source. The first frame is an analog signal at the point in time when the first frame is received by the wireless transmitting/receiving part 11.

The wireless transmitting/receiving part 11 performs frequency conversion of the received first frame into a signal of an appropriate frequency band. The wireless transmitting/receiving part 11 outputs the frequency-converted first frame to the ADC part 14.

The ADC part 14 shown in FIG. 2 converts the first frame received from the wireless transmitting/receiving part 11 into a digital signal. The ADC part 14 outputs the first frame converted into a digital signal to the demodulating part 12.

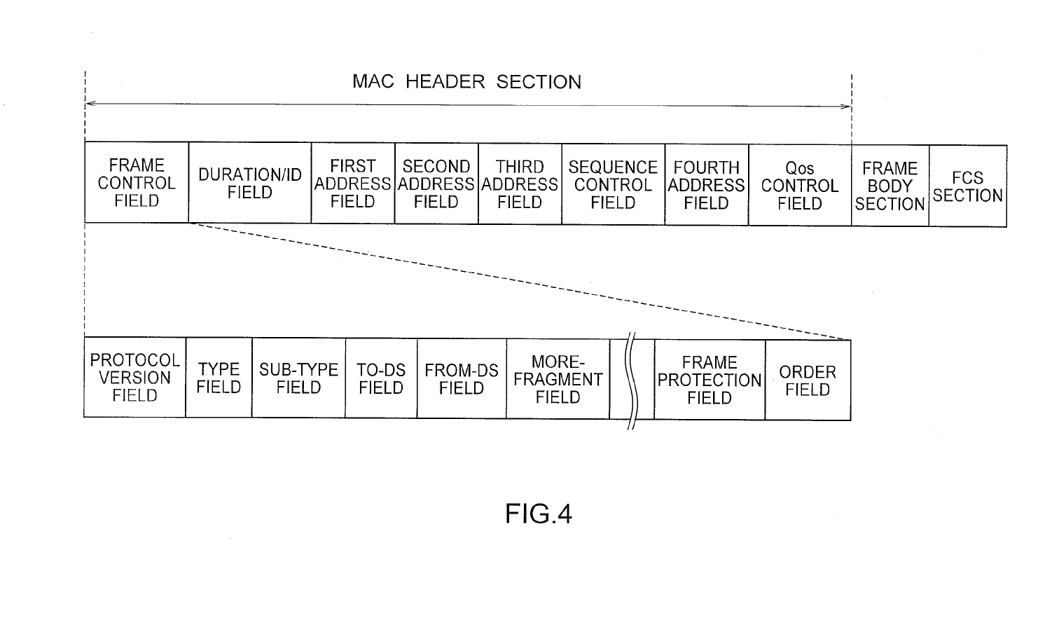

The demodulating part 12 shown in FIG. 2 performs a reception processing including a predetermined demodulation processing and a predetermined decoding processing that comply with IEEE 802.11. More specifically, the demodulating part 12 converts the first frame received from the ADC part 14 into a MAC frame (see FIG. 4) defined in IEEE 802.11. The demodulating part 12 outputs the first frame converted into a MAC frame to the MAC layer part 15.

More specifically, the demodulating part 12 performs an orthogonal frequency-division multiplexing (OFDM) symbol timing synchronizing processing, a fast Fourier transform (FFT) processing, a deinterleaving processing and an error correction decoding processing on the first frame received from the ADC part 14, for example.

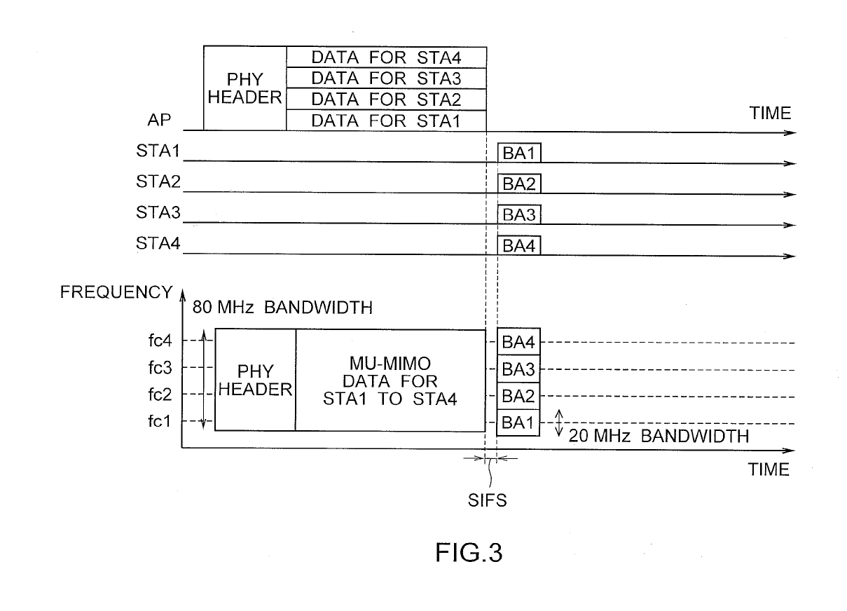

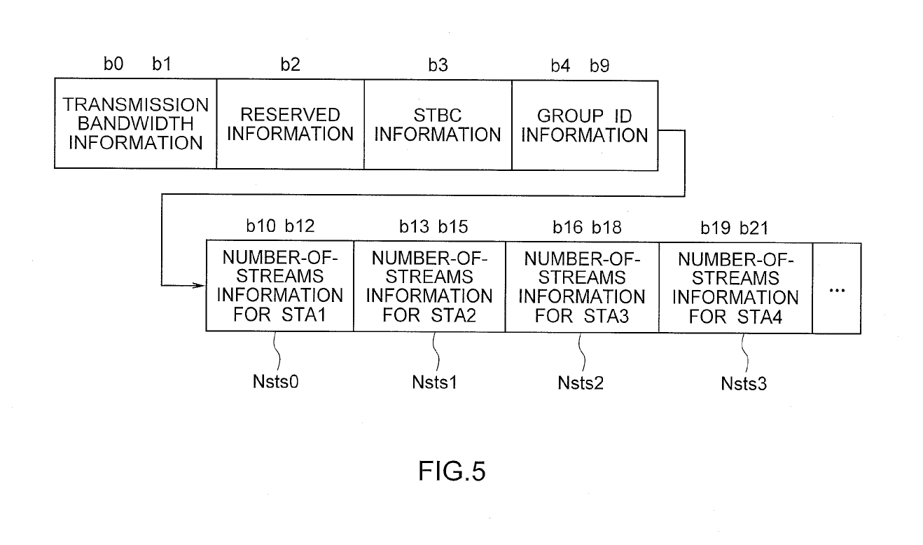

More specifically, the demodulating part 12 extracts information on the length of the first frame, the transmission rate of the first frame, bandwidth information indicating the bandwidth of the first frame or the like based on a physical (PHY) header (see FIGS. 3 and 5) of the first frame. The demodulating part 12 uses the extracted information for the demodulating processing described above or outputs the extracted information to the MAC layer part 15.

As shown in FIG. 2, the response channel selecting part 121 is provided in the demodulating part 12. The response channel selecting part 121 selects a response channel used for transmission of a response frame back to the second wireless communication device 2, based on the information included in the first frame received by the wireless transmitting/receiving part 11.

More specifically, the response channel selecting part 121 recognizes (decides) an ordinal rank for response channel selection based on the information included in the first frame, and selects a response channel corresponding to the recognized (decided) ordinal rank. The response channel selecting part 121 outputs the result of the response channel selection to the multiplexing part 18 as a control signal.

The ordinal rank for response channel selection is an ordinal rank of each of the plurality of first wireless communication devices 1, which are destinations of the plurality of pieces of data spatially multiplexed in the first frame. Therefore, each first wireless communication device 1 has a different ordinal rank for response channel selection.

As described above, owing to the response channel selecting part 121, the first wireless communication device 1 can recognize the ordinal rank for the response channel assigned to the first wireless communication device 1 itself, that is, the terminal itself, to be selected. Owing to the response channel selecting part 121, the first wireless communication device 1 can select the response channel that is different from those assigned to the other first wireless communication devices 1.

As described above, since each of the plurality of first wireless communication devices 1 is provided with the response channel selecting part 121, the first wireless communication devices 1 can simultaneously transmit the respective response frames in different response channels.

FIG. 3 is a time chart showing an example of an operation of the wireless communication device 1 according to the first embodiment. FIG. 3 shows an example of simultaneous transmission of response frames by a plurality of first wireless communication devices 1. More specifically, FIG. 3 shows an example of simultaneous transmission of block acknowledgements “BA1” to “BA4” in different response channels “fc1” to “fc4” by four stations “STA1” to “STA4”. Note that the “block acknowledgement” is an example of the response frame.

In the example shown in FIG. 3, the first to fourth stations “STA1” to “STA4” have lower ordinal ranks for response channel selection in ascending order of ordinal numbers. Furthermore, in the example shown in FIG. 3, a unit bandwidth of the block acknowledgement is 20 MHz, and a transmission bandwidth of the first frame is 80 MHz.

As shown in FIG. 2, the oscillating part 13 is connected to the multiplexing part 18. The multiplexing part 18 is disposed on an output side of the response channel selecting part 121 and on an input side of the wireless transmitting/receiving part 11. The oscillating part 13 outputs a carrier signal of a frequency corresponding to the response channel selected by the response channel selecting part 121 to the wireless transmitting/receiving part 11.

More specifically, as shown in FIG. 2, the oscillating part 13 is formed by five oscillators 13a to 13e, that is, a first oscillator 13a, a second oscillator 13b, a third oscillator 13c, a fourth oscillator 13d and a fifth oscillator 13e. Each of the oscillators 13a to 13e outputs a carrier signal of a different center frequency to the multiplexing part 18.

The multiplexing part 18 shown in FIG. 2 selects one oscillator specified by the control signal input thereto from the response channel selecting part 121 from among the oscillators 13a to 13e, and inputs the carrier signal oscillated by the selected oscillator to the wireless transmitting/receiving part 11. In this way, the carrier signal from the one oscillator 13 input to the wireless transmitting/receiving part 11 is used for transmission of the response frame by the wireless transmitting/receiving part 11.

The oscillators 13a to 13e are used not only for response channel selection in transmission of the response frame but also for frequency channel selection in transmission and reception by the wireless transmitting/receiving part 11. For example, the oscillators 13a to 13e are used also for selection of a frequency channel used for reception of the first frame.

In the example shown in FIG. 2, a plurality of oscillators are provided. However, an arrangement is also possible in which one oscillator is provided, and the oscillator selectively outputs a carrier signal of one of a plurality of different center frequencies.

The MAC layer part 15 shown in FIG. 2 generates the response frame, that is, a block acknowledgement frame, as a MAC frame. The MAC layer part 15 outputs the generated response frame to the modulating part 16.

Besides the response frame, the MAC layer part 15 may generate a data frame, an acknowledgement (ACK) frame or a clear to send (CTS) frame as a MAC frame.

The modulating part 16 shown in FIG. 2 performs a transmission processing including a predetermined modulation processing and a predetermined encoding processing that comply with IEEE 802.11 on the response frame received from the MAC layer part 15. The modulating part 16 outputs the response frame subjected to the modulation processing and encoding processing and the like to the DAC part 17.

The DAC part 17 shown in FIG. 2 converts the response frame received from the modulating part 16, which is a digital signal, into an analog baseband signal. The DAC part 17 outputs the response frame converted into an analog signal to the wireless transmitting/receiving part 11.

The wireless transmitting/receiving part 11 shown in FIG. 2 up-converts the baseband signal of the response frame received from the DAC part 17 to the frequency corresponding to the response channel. The wireless transmitting/receiving part 11 transmits the up-converted baseband signal representing the response frame to the second wireless communication device 2 via the antenna 11a.

That is, the wireless transmitting/receiving part 11 transmits the response frame in the response channel using the carrier signal output from the oscillating part 13.

Next, the arrangement for response channel selection and the first frame will be described in more detail.

The wireless transmitting/receiving part 11 receives ordinal rank information that indicates the preset ordinal rank of the first wireless communication device 1. The ordinal rank information is transmitted from the second wireless communication device 2. The ordinal rank information indicates the ordinal rank of each of the plurality of first wireless communication devices 1, which are destinations of the plurality of data spatially multiplexed in the first frame. Therefore, the ordinal rank indicated by the ordinal rank information differs between the first wireless communication devices 1.

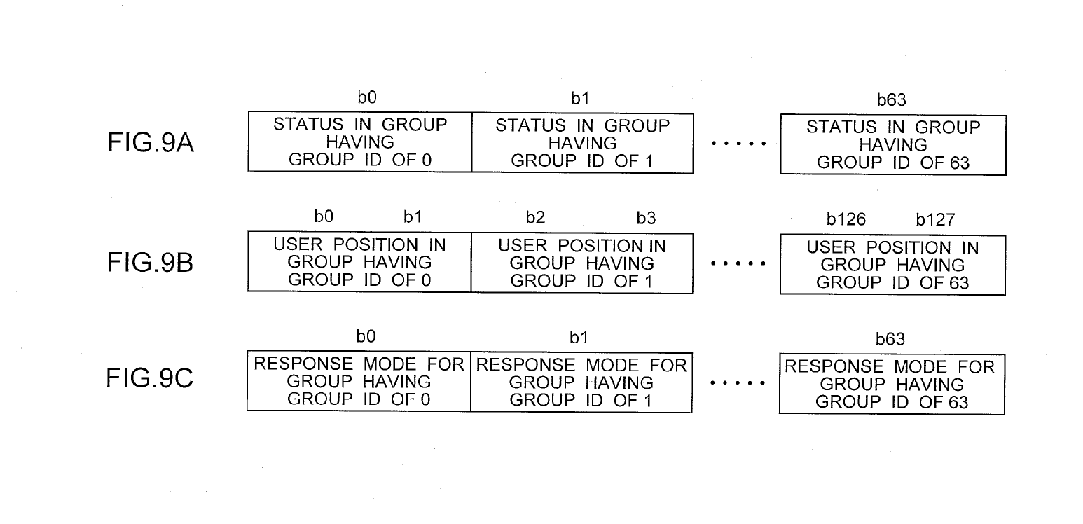

The wireless transmitting/receiving part 11 may receive the ordinal rank information before receiving the first frame or along with the first frame. The ordinal rank information is user position information (see FIG. 9B) described later, for example.

The first frame includes number-of-data information that indicates the number of pieces of data destined for addresses of a plurality of first wireless communication devices 1. In the number-of-data information, the number of pieces of data for any first wireless communication device 1 is associated with the ordinal rank indicated by the ordinal rank information on the first wireless communication device 1. That is, in the number-of-data information, the number of pieces of data for a wireless communication device is associated with the ordinal rank of the wireless communication device indicated in the ordinal rank information. The number-of-data information is number-of-streams information (see FIG. 5) described later, for example.

When the response channel selecting part 121 refers to the number-of-data information, there may be an ordinal rank with which no data is associated that is higher than the ordinal rank of the first wireless communication device 1 indicated in the ordinal rank information (that is, the terminal itself). In such a case, the response channel selecting part 121 recognizes, as the ordinal rank for response channel selection, the ordinal rank of the first wireless communication device 1 indicated by the ordinal rank information advanced by the number of ordinal ranks with which no data is associated.

The “ordinal rank with which no data is associated” means an ordinal rank the number of pieces of data associated with which indicated in the number-of-data information is 0.

On the other hand, when the response channel selecting part 121 refers to the number-of-data information, there may not be any ordinal rank with which no data is associated that is higher than the ordinal rank of the first wireless communication device 1 indicated in the ordinal rank information. In such a case, the response channel selecting part 121 recognizes the ordinal rank of the first wireless communication device 1 indicated by the ordinal rank information as the ordinal rank for response channel selection.

To any first wireless communication device 1 that holds an ordinal rank with which no data is associated (that is, the number of pieces of data associated with which is zero), no data is transmitted from the second wireless communication device 2. Therefore, such a first wireless communication device does not need to transmit the response frame. Therefore, any first wireless communication device 1 that holds an ordinal rank with which no data is associated can be excluded from the ranking for response channel selection.

Since any first wireless communication device 1 that holds an ordinal rank with which no data is associated is excluded from the ranking for response channel selection, simultaneous transmission in response channels by a plurality of first wireless communication devices 1 can be ensured as far as possible even if the bandwidth of the first frame is narrow.

In this embodiment, the response channel selecting part 121 obtains a comparison value used for comparison with the ordinal rank for response channel selection, based on the bandwidth information described above. The bandwidth information is transmission bandwidth information (see FIG. 5) described later.

The response channel selecting part 121 compares the obtained comparison value with the ordinal rank for response channel selection.

The comparison value is the bandwidth of the first frame divided by the unit bandwidth of the block acknowledgement described later, for example. In the case shown in FIG. 3 described above, the comparison value is 4, since the bandwidth of the first frame is 80 MHz, and the unit bandwidth of the block acknowledgement is 20 MHz.

If the comparison of the comparison value with the ordinal rank for response channel selection shows that the comparison value is equal to or higher than the ordinal rank for response channel selection, the response channel selecting part 121 selects a response channel.

On the other hand, if the comparison of the comparison value with the ordinal rank for response channel selection shows that the comparison value is lower than the ordinal rank for response channel selection, the response channel selecting part 121 does not select any response channel.

In the example shown in FIG. 3, the ordinal rank for response channel selection of the first station “STA1” is “1”, which is the top rank. The ordinal rank for response channel selection for the fourth station “STA4” is “4”, which is the bottom rank. In the example shown in FIG. 3, the comparison value “4” is equal to or greater than the ordinal ranks for response channel selection of all the first wireless communication devices 1 (“STA1” to “STA4”).

Therefore, in the example shown in FIG. 3, regardless of the ordinal rank, all the first wireless communication devices 1 select response channels corresponding to the ordinal ranks.

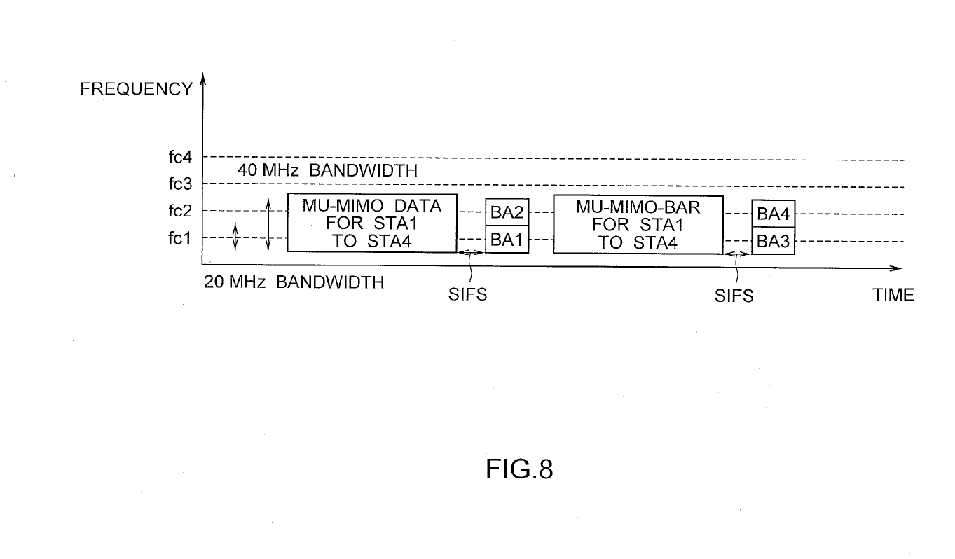

In the example shown in FIG. 8 described later, since the bandwidth of the first frame is 40 MHz and the unit bandwidth of the block acknowledgement is 20 MHz, the comparison value is 2. When the comparison value is “2” as in the example shown in FIG. 8, the response channel selecting part 121 does not select any response channel if the ordinal rank of the first wireless communication device 1 is lower than “2”.

Since whether to select a response channel or not is determined based on the result of comparison between the ordinal rank for response channel selection and the bandwidth of the first frame, the response frame can be transmitted back with reliability.

In this embodiment, furthermore, the first frame includes necessity information that indicates whether transmission of the response frame is necessary or not. The necessity information is Ack policy information in a quality of service (QoS) control field (see FIG. 4) in a MAC header section described later.

If the necessity information shows that transmission of the response frame is necessary, the response channel selecting part 121 selects a response channel.

On the other hand, if the necessity information shows that transmission of the response frame is not necessary, the response channel selecting part 121 does not select any response channel.

Since whether to select a response channel or not is determined based on the necessity information as described above, unnecessary communication can be prevented.

Next, an example of an operation according to this embodiment will be described.

In this embodiment, in the first wireless communication device 1, the wireless transmitting/receiving part 11 receives the first frame, which has the structure shown in FIGS. 4 and 5, from the second wireless communication device 2. FIG. 4 is a diagram for illustrating a MAC frame format defined in IEEE 802.11. FIG. 5 is a diagram for illustrating a PHY header format of a MU-MIMO frame defined in IEEE 802.11ac.

As shown in FIG. 4, the MAC frame includes a MAC header section, a frame body section and a frame check sequence (FCS) section.

In the MAC header section, information required for a reception processing in a MAC layer is set. In the frame body section, information that depends on the type of the frame (such as data from an upper layer) is set. In the FCS section, a cyclic redundancy code (CRC) is set. The CRC is used for determining whether the MAC header section and the frame body section have been properly received or not.

As shown in FIG. 4, the MAC header section includes a frame control field, a duration/ID field, first to fourth address fields, a sequence control field and a QoS control field.

In the frame control field, a value that depends on the type of the frame is set. The duration/ID field shows a duration (network allocation vector (NAV)) for which transmission is waited for.

In the first address field, a MAC address of a direct receiving station is set. In the second address field, a MAC address of a direct transmitting station is set. In the third address field, a MAC address of a final destination device is set in an uplink or a MAC address of a transmission source device is set in a downlink.

The fourth address field exits only when a wireless base station transmits to another wireless base station. In the fourth address field, a MAC address of a transmission source device is set. In the sequence control field, a sequence number of data to be transmitted or a fragment number of any fragmented data is set.

As shown in FIG. 4, the frame control field includes a protocol version field, a type field, a sub-type field, a to-DS field, a from-DS field, a more-fragment field, a frame protection field and an order field, for example.

The type field indicates the type of the frame. In the type field, a bit string is set which indicates to which frame type, a control frame, a management frame or a data frame, the frame belongs.

In the sub-type field, a bit string is set which indicates the type of the MAC frame for each frame type.

In the to-DS field, information is set which indicates whether the receiving station is a wireless base station or a wireless terminal.

In the from-DS field, information is set which indicates whether the transmitting station is a wireless base station or a wireless terminal.

The more-fragment field holds information that indicates whether there is a subsequent fragment frame when data is fragmented.

In the frame protection field, information is set which indicates whether the first frame is protected or not.

In the order field, information is set which indicates that the order of frames must not be changed when frames are relayed.

If the received frame is a QoS data frame, the QoS control field is additionally provided. On the other hand, if the received frame is non-QoS data, the QoS control field is not additionally provided. The first wireless communication device 1 can recognize the received frame as a QoS data frame by recognizing the received frame as a data frame based on the type field and then checking the bit string in the sub-type field.

The QoS control field includes a TID field, an Ack policy field or the like (not shown).

In the TID field, an identifier that depends on a data traffic is set. There are 16 types of TID fields (TID fields 0 to 15). In the Ack policy field, a delivery confirmation scheme is set. The first wireless communication device 1 can recognize the traffic type of the data by checking the TID field. The first wireless communication device 1 can determine in which policy, a normal Ack policy, a block Ack policy or a no-Ack policy, the QoS data has been transmitted, by checking the Ack policy field.

As shown in FIGS. 5 and 3, at the head of the first frame, the PHY header is provided. The PHY header defined in IEEE 802.11ac standard is formed by a legacy preamble field, a legacy signal field, a VHT signal-A field, and a VHT signal-B field (not shown), for example.

The legacy preamble field and the legacy signal field are fields added to maintain backward compatibility. Owing to the legacy preamble field and the legacy signal field, the first wireless communication device 1 can detect a wireless terminal complying with a standard (802.11a or 802.11n, for example) that precedes IEEE 802.11ac. The legacy signal field includes information used for calculating a frame transmission time.

The VHT signal-A field and the VHT signal-B field include transmission bandwidth information, group ID information, number-of-streams information (Nsts) for each station, and rate information. These pieces of information are defined in IEEE 802.11ac standard. The number-of-streams is the number of streams spatially multiplexed. This means the number of different data to be transmitted on the same frequency channel at the same time.

As shown in FIG. 5, the VHT signal-A field includes transmission bandwidth information, reserved information, space-time block code (STBC) information, group ID information, and number-of-streams information for each station.

As shown in FIG. 5, the transmission bandwidth information corresponds to bits 0 (b0) to 1 (b1) of the VHT signal-A field. The reserved information corresponds to a bit 2 (b2). The STBC information corresponds to a bit 3 (b3). The STBC information indicates whether a STBC is applied or not.

As shown in FIG. 5, the group ID information corresponds to bits 4 (b4) to 9 (b9) of the VHT signal-A field.

The number-of-streams information indicated as Nsts0 to Nsts3 occupies bits 10 (b10) to 21 (b21), the number-of-streams information for each station occupying 3 bits.

To find which of Nsts0 to Nsts3 is the number-of-streams information for the device itself, information referred to as user position information is needed.

Once a first wireless communication device belongs to the network established by the second wireless communication device 2, the second wireless communication device 2 notifies the first wireless communication device 1 of the group ID information and the user position information. The group ID information can assume a value from “0” to “63”. The group ID information used in DL-MU-MIMO is “1” to “62”. The user position information can assume a value from “0” to “3”.

The second wireless communication device 2 notifies the first wireless communication device 1 to which group of the groups “1” to “62” the first wireless communication device 1 belongs. This notification is, for example, of group ID. The second wireless communication device 2 then notifies the first wireless communication device 1 of the user position of the first wireless communication device 1 in the group of which the first wireless communication device 1 is notified. The first wireless communication device 1 can belong to a plurality of groups.

For example, suppose that all of the first to fourth stations “STA1” to “STA4” have a group ID of “1”. In addition, suppose that the user position information for the first station “STA1” is “0”, the user position information for the second station “STA2” is “1”, the user position information for the third station “STA3” is “2”, and the user position information for the fourth station “STA4” is “3”.

In this case, the first station “STA1” extracts the value at the bit positions of Nsts0 in the first frame as the number-of-streams information corresponding to the user position information “0”. The second station “STA2” extracts the value at the bit positions of Nsts1 in the first frame as the number-of-streams information corresponding to the user position information “1”. Similarly, the third station “STA3” extracts the value at the bit positions of Nsts2, and the fourth station “STA4” extracts the value at the bit positions of Nsts3.

The fact that the value at the bit positions of Nsts is “0” means that there is no data stream at the corresponding user position. At the user position at which there is a data stream, the corresponding Nsts value is “1” or greater.

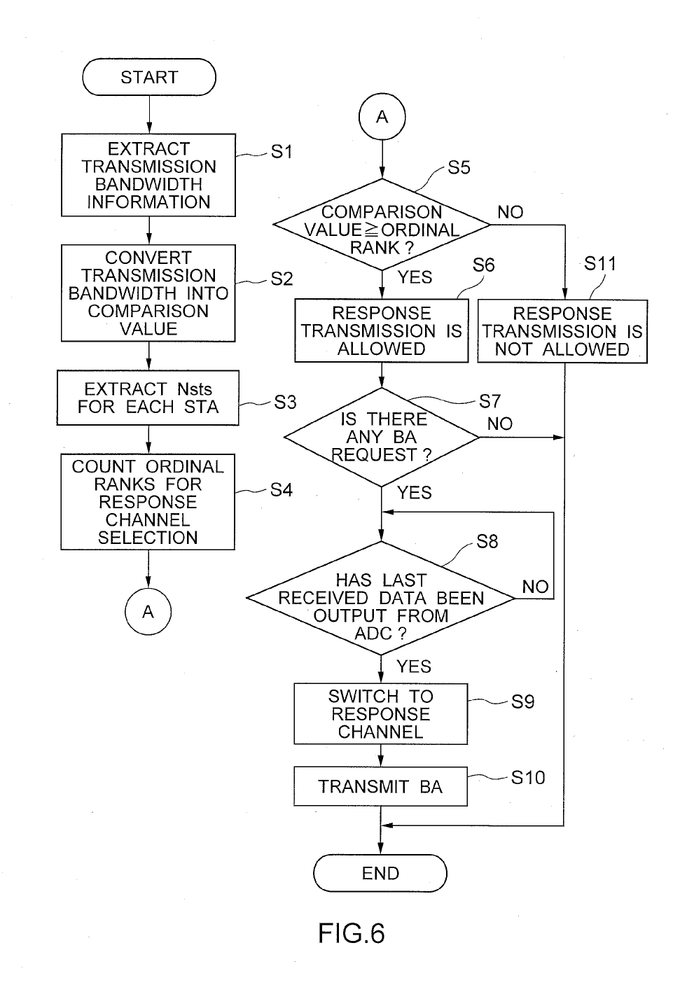

After the first wireless communication device 1 receives the first frame described above, the first wireless communication device 1 performs the steps shown in the flowchart of FIG. 6. FIG. 6 is a flowchart showing an example of an operation of the wireless communication device 1 according to the first embodiment.

First, in a first step (S1) in FIG. 6, the response channel selecting part 121 extracts the transmission bandwidth information from the first frame.

In this step, the response channel selecting part 121 extracts the transmission bandwidth information based on the PHY header section shown in FIG. 5. It is supposed that the transmission bandwidth information is “0” if the transmission bandwidth information indicates a bandwidth of 20 MHz, “1” if the transmission bandwidth information indicates a bandwidth of 40 MHz, “2” if the transmission bandwidth information indicates a bandwidth of 80 MHz, and “3” if the transmission bandwidth information indicates a bandwidth of 160 MHz.

As shown in FIG. 3, if the transmission bandwidth is 80 MHz, “2” is extracted as the transmission bandwidth information.

In a second step (S2), the response channel selecting part 121 then converts the transmission bandwidth information extracted in the first step (S1) into a comparison value.

It is supposed that the comparison value corresponding to the transmission bandwidth information “0” is “1”, the comparison value corresponding to the transmission bandwidth information “1” is “2”, the comparison value corresponding to the transmission bandwidth information “2” is “4”, and the comparison value corresponding to the transmission bandwidth information “3” is “8”. The comparison value corresponds to the maximum number of frames of a bandwidth of 20 MHz that can be arranged in parallel. If the unit bandwidth of the block acknowledgement is 20 MHz, the comparison value is the transmission bandwidth 80 MHz divided by the unit bandwidth of the block acknowledgement.

In a third step (S3), the response channel selecting part 121 then extracts the number-of-streams information Nsts for each station.

In this step, the response channel selecting part 121 holds the number-of-streams information Nsts for each station in a bit map format. The processing of holding the number-of-streams information in the bit map format is a processing of checking whether the value of the number-of-streams information Nsts for each station is “0” or not. This processing can be implemented by the response channel selecting part 121 executing a program expressed by the following program listing, for example.

Nsts_{—}btmp={(|Nsts3[2:0]),(|Nsts2[2:0]),(|Nsts1[2:0]),(|Nsts0[2:0])}

Here, “(|A[2:0])” means to calculate a logical OR of the bits of A. That is, “(|A[2:0])” means A[2], A[1] or A[0]. {a, b, c, d} means bit combination. That is, if a=1, b=0, c=1, and d=1, Nsts_btmp=4′b1011 (a binary expression of four bits).

In a fourth step (S4), the response channel selecting part 121 then counts the ordinal ranks for response channel selection based on the number-of-streams information Nsts extracted in the third step (S3). The processing of the fourth step (S4) can be implemented by the response channel selecting part 121 executing a program expressed by the following program listing, for example.

for (i=0;i<=MyPosition[GroupID];i++;){if (Nsts_{—}btmp[i]){PosiCount=PosiCount+1;}}

Here, “Myposition[GroupID]” indicates the value of the user position information of the terminal itself with respect to the group ID set in the received frame and can assume an integer “0” to “3”. Any first wireless communication device 1 that belongs to the second wireless communication device 2 knows the user position information in advance since the first wireless communication device 1 is notified of the user position information in advance by the second wireless communication device 2.

Suppose that the first wireless communication device 1 is the third station “STA3”. In addition, suppose that “MyPosition” of the first wireless communication device 1 is “2”. Furthermore, suppose that Nsts for each station in the bit map format held by the response channel selecting part 121 is Nsts_btmp=4′b1111.

In this case where Nsts_btmp=4′b1111, the response channel selecting part 121 recognizes “3” as the ordinal rank for response channel selection. This ordinal rank is the same as the ordinal rank indicated by the user position information.

As another example, suppose that “MyPosition” of the first wireless communication device 1 is “2”, and the Nsts information for each station in the bit map format indicates Nsts_btmp=4′b1110. This “4′b1110” means that the number of streams for the first station “STA1”, which is at an upper user position than the third station “STA3”, that is, the terminal itself, is 0.

In this case where Nsts_btmp=4′b1110, the response channel selecting part 121 recognizes “2”, which is advanced by 1 from the user position, as the ordinal rank for response channel selection.

In a fifth step (S5), the response channel selecting part 121 then determines whether or not the comparison value obtained by the conversion in the second step (S2) is equal to or greater than the ordinal rank for response channel section recognized in the fourth step (S4).

If the result of the determination in the fifth step (S5) is positive, the process proceeds to a sixth step (S6). On the other hand, if the result of the determination in the fifth step (S5) is negative, the process proceeds to an eleventh step (S11).

If it is supposed that the comparison value of the third station “STA3” is “4”, and the ordinal rank for response channel selection of the third station “STA3” is “3”, the comparison value is greater than the ordinal rank for the third station “STA3”, so that the response channel selecting part 121 of the third station “STA3” determines that the response frame can be transmitted back.

On the other hand, if it is supposed that the transmission bandwidth of the first frame received by the third station “STA3” is 20 MHz, and the comparison value corresponding to 20 MHz is “1”, the comparison value is smaller than the ordinal rank “3” for response channel selection. In this case, the response channel selecting part 121 of the third station “STA3” determines that the response frame cannot be transmitted back.

When the process proceeds from the fifth step (S5) to the sixth step (S6), the response channel selecting part 121 determines that the response frame can be transmitted back, and the process proceeds to a seventh step (S7).

On the other hand, when the process proceeds from the fifth step (S5) to the eleventh step (S11), the response channel selecting part 121 determines that the response frame cannot be transmitted back, and the process ends.

In the seventh step (S7), the MAC layer part 15 then determines whether the second wireless communication device 2 is requesting for a block acknowledgement (BA) or not.

If the result of the determination in the seventh step (S7) is positive, the process proceeds to an eighth step (S8). On the other hand, if the result of the determination in the seventh step (S7) is negative, the process ends.

In the seventh step (S7), the MAC layer part 15 analyzes the MAC header section (see FIG. 4), and determines that a block acknowledgement is being requested if the MAC layer part 15 confirms that the Ack policy of the QoS control field in the MAC header section is the normal Ack. If the MAC layer part 15 determines that a block acknowledgement is being requested, the MAC layer part 15 notifies the response channel selecting part 121 that a block acknowledgement is being requested.

If the Ack policy is not the normal Ack, the MAC layer part 15 determines that no block acknowledgement is being requested.

In the eight step (S8), the response channel selecting part 121 then determines whether the last received data has been output from the ADC part 14 or not. This determination is equivalent to a determination of whether the received data has been entirely loaded into a processing block subsequent to the ADC part 14 or not.

If the result of the determination in the eighth step (S8) is positive, the process proceeds to a ninth step (S9). On the other hand, if the result of the determination in the eighth step (S8) is negative, the eighth step (S8) is repeated.

In the ninth step (S9), the response channel selecting part 121 then switches the frequency channel of the wireless transmitting/receiving part 11 to the response channel.

A prerequisite of the ninth step (S9) is that the frequency channel of the wireless transmitting/receiving part 11 before the switching to the response channel is the frequency channel corresponding to one of the plurality of oscillators 13a to 13e, that is, the reception channel of the first frame.

The oscillators other than the oscillator that corresponds to the reception channel of the first frame become active, that is, become able to immediately output a carrier signal if the demodulating part 12 recognizes the first frame that indicates the group ID information for the terminal itself (for example, if the demodulating part 12 recognizes that CRC in a VHT SIGA field of the PHY header is OK). Such control of the oscillating part may be performed by a controlling part (not shown) of the first wireless communication device 1.

The ninth step (S9) may be performed in a period of approximately 2 μs after the eighth step (S8).

Here, a specific example of the response channel will be described. For example, suppose that the wireless communication system 3 establishes communication in a 5.2 GHz band (5150 MHz to 5250 MHz). And suppose that the center frequency “fc1” of the response channel that corresponds to the ordinal rank “1” for response channel selection is 5180 MHz. Furthermore, suppose that the center frequency “fc2” of the response channel that corresponds to the ordinal rank “2” for response channel selection is 5200 MHz. Furthermore, suppose that the center frequency “fc3” of the response channel that corresponds to the ordinal rank “3” for response channel selection is 5220 MHz. Furthermore, suppose that the center frequency “fc4” of the response channel that corresponds to the ordinal rank “4” for response channel selection is 5240 MHz.

The correspondence between the ordinal ranks for response channel selection and the center frequencies “fc1” to “fc4” of the response channels is stored in advance in the second wireless communication device 2 and the respective first wireless communication devices 1, which are destinations of the first frame.

Furthermore, suppose that the center frequency of the first oscillator 13a is 5180 MHz, the center frequency of the second oscillator 13b is 5200 MHz, the center frequency of the third oscillator 13c is 5220 MHz, and the center frequency of the fourth oscillator 13d is 5240 MHz.

If it is further supposed that the ordinal rank for response channel selection is “3”, the response channel selecting part 121 connects the third oscillator 13c to the wireless transmitting/receiving part 11 based on the correspondence between the ordinal rank and the frequency. This connection to the wireless transmitting/receiving part 11 allows the third oscillator 13c to input a carrier signal of a center frequency of 5220 MHz to the wireless transmitting/receiving part 11. In response to the input of the carrier signal, the response channel selecting part 121 switches the center frequency of the wireless transmitting/receiving part 11 to 5220 MHz.

In a tenth step (S10), the wireless transmitting/receiving part 11 then transmits a block acknowledgement to the second wireless communication device 2 in the response channel selected in the ninth step (S9).

The transmission of the block acknowledgement by the wireless transmitting/receiving part 11 may be performed after a lapse of a short interframe space (SIFS) (16 μs) from the end of the first frame by the MAC layer part 15 controlling the response channel selecting part 121.

By the operation of the first wireless communication devices 1, the stations “STA1” to “STA4” can simultaneously transmit block acknowledgements “B1” to “B4” as shown in FIG. 3.

According to this embodiment, the first wireless communication devices 1 can recognize the respective ordinal ranks for response channel selection based on the information included in the first frame, and select different response channels according to the respective recognized ordinal ranks.

Thus, the first wireless communication devices 1 can simultaneously transmit the response frames in different response channels. Therefore, the throughput of the wireless LAN communication can be easily improved, compared with the case where the first wireless communication devices 1 transmit the response frame in series.

### Second Embodiment

Next, a second embodiment will be described. In the description of this embodiment, components corresponding to those in the first embodiment will be denoted by the same reference numerals, and redundant description thereof will be omitted.

The response channel selecting part 121 according to this embodiment may detect that transmission of the response frame is not necessary based on the request information (the Ack policy, for example) included in the first frame after response channel selection. In that case, the response channel selecting part 121 selects the frequency channel in which the first frame has been received instead of the response channel.

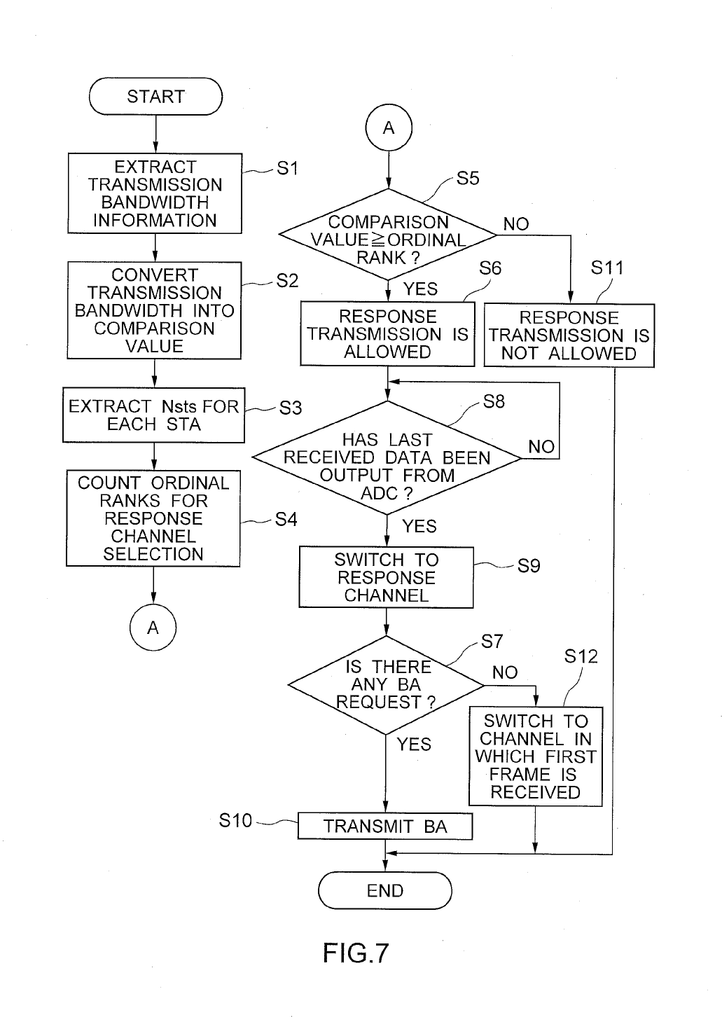

FIG. 7 is a flowchart showing an example of an operation of the wireless communication device 1 according to the second embodiment. The flowchart of FIG. 7 differs from the flowchart of FIG. 6 in when the seventh step (S7) is performed. Specifically, the seventh step (S7) is performed following the ninth step (S9).

Furthermore, according to the flowchart of FIG. 7, if it is determined in the seventh step (S7) that no block acknowledgement is requested, a twelfth step (S12) is performed. In the twelfth step (S12), the response channel selecting part 121 switches the frequency of the wireless transmitting/receiving part 11 to the reception channel of the first frame, and the process ends.

The first wireless communication device 1 according to this embodiment can switch the frequency of the wireless transmitting/receiving part 11 to the frequency of the reception channel of the first frame and wait for reception of the first frame, when it is detected that no block acknowledgement is requested after switching to the response channel.

The remainder of the operation according to the second embodiment is the same as that according to the first embodiment. Therefore, the second embodiment further has the advantages of the first embodiment.

### Third Embodiment

Next, a third embodiment will be described. In the description of this embodiment, components corresponding to those in the first embodiment will be denoted by the same reference numerals, and redundant description thereof will be omitted.

According to this embodiment, if the response channel selecting part 121 is not to select any response channel but the wireless transmitting/receiving part 11 receives a request signal for transmission of a response frame, the response channel selecting part 121 recognizes the ordinal rank for response channel selection based on the information included in the received request signal. The response channel selecting part 121 then selects a response channel that corresponds to the recognized ordinal rank.

FIG. 8 is a time chart showing an example of an operation of the wireless communication device 1 according to the third embodiment.

(Data Transmission)

In the example shown in FIG. 8, as the user position information for a group ID of 1, “0” is set for the first station “STA1”, “1” is set for the second station “STA2”, “2” is set for the third station “STA3”, and “3” is set for the fourth station “STA4”.

In the example shown in FIG. 8, the second wireless communication device 2, that is, the access point, transmits a data frame to each station “STA1” to “STA4” in the MU-MIMO scheme. The Ack policy of the data is the Normal Ack policy. That is, the second wireless communication device 2 requests a block acknowledgement BA from each station “STA1” to “STA4”. Furthermore, in the example shown in FIG. 8, the PHY header of the data frame transmitted by the second wireless communication device 2 include “1”, which indicates a bandwidth of 40 MHz, as the transmission bandwidth information. The PHY header further includes “1” as the group ID information. The PHY header further includes Nsts0 of “1”, Nsts1 of “1”, Nsts2 of “1” and Nsts3 of “1” as the number-of-streams information.

Furthermore, in the example shown in FIG. 8, as described above, the transmission bandwidth of the first frame is 40 MHz, that is, the comparison value is “2”, while the ordinal rank for response channel selection of the third station “STA3” is “3”, which is greater than the comparison value. Furthermore, the ordinal rank for response channel selection of the fourth station “STA4” is “4”, which is also greater than the comparison value.

Therefore, the third and fourth stations “STA3” and “STA4” do not select any response channel, and the first and second stations “STA1” and “STA2” at higher ordinal ranks do not simultaneously transmit the respective response frames.

In FIG. 8, the first and second stations “STA1” and “STA2” first simultaneously transmit the respective response frames. More specifically, the first station “STA1” transmits the block acknowledgement “BA1” in “fc1” shown in FIG. 8, and at the same time, the second station “STA2” transmits the block acknowledgement “BA2” in “fc2” shown in FIG. 8.

(BAR Transmission)

The second wireless communication device 2 then transmits a Block Ack Request (BAR) frame to the third and fourth stations “STA3” and “STA4” in the MU-MIMO scheme. The BAR frame is a frame in which a BAR itself requests a block acknowledgement BA. The BAR frame is an example of the request signal.

The PHY header of the BAR frame includes “1”, which indicates a bandwidth of 40 MHz, as the transmission bandwidth information. The PHY header further includes “1” as the group ID information. The PHY header further includes Nsts0 of “0”, Nsts1 of “0”, Nsts2 of “1” and Nsts3 of “1” as the number-of-streams information.

The third and fourth stations “STA3” and “STA4” receive the BAR frame transmitted from the second wireless communication device 2.

The response channel selecting part 121 of the third station “STA3” then recognizes the ordinal rank for response channel selection based on the information included in the PHY header of the BAR frame, and selects “fc1” shown in FIG. 8 as the response channel that corresponds to the recognized ordinal rank.

The response channel selecting part 121 of the fourth station “STA4” recognizes the ordinal rank for response channel selection based on the information included in the PHY header of the BAR frame, and selects “fc2” shown in FIG. 8 as the response channel that corresponds to the recognized ordinal rank.

The third and fourth stations “STA3” and “STA4” then simultaneously transmit the block acknowledgements “BA3” and “BA4” using the selected response channels “fc1” and “fc2”, respectively.

On the other hand, the first and second stations “STA1” and “STA2” does not perform transmission, because there is no frame destined for the first and second stations “STA1” and “STA2”.

As described above, the third and fourth stations “STA3” and “STA4” simultaneously transmit the respective response frames after a lapse of SIFS from the reception of the BAR frame.

According to this embodiment, even when the transmission bandwidth of the first frame is narrow, and the all of the stations that are destinations of the first frame cannot simultaneously transmit the respective block acknowledgements, a station at a lower ordinal rank can transmit the block acknowledgement in response to the BAR. Furthermore, if there are a plurality of stations at lower ordinal ranks, the plurality of stations at lower ordinal ranks can simultaneously transmit the respective block acknowledgements.

If the BAR frame is received, the response channel selecting part 121 may recognize, as the ordinal rank for response channel selection, an ordinal rank advanced by the number of other first wireless communication devices 1 that have already transmitted the respective response frames, based on the information included in the BAR frame. Then, the response channel selecting part 121 can select the response channel that corresponds to the advanced ordinal rank.

The remainder of the operation according to the third embodiment is the same as that according to the first embodiment. Therefore, the third embodiment further has the advantages of the first embodiment.

### Fourth Embodiment

Next, a fourth embodiment will be described. In the description of this embodiment, components corresponding to those in the first embodiment will be denoted by the same reference numerals, and redundant description thereof will be omitted.

According to this embodiment, the first frame is a frame of spatially multiplexed data destined for addresses of a plurality of first wireless communication devices to which a same group ID is assigned. The first frame includes response mode information that indicates a response scheme of the response frame. The response mode information is associated with the group ID. Furthermore, the response mode information associated with the same group ID indicates a common response scheme.

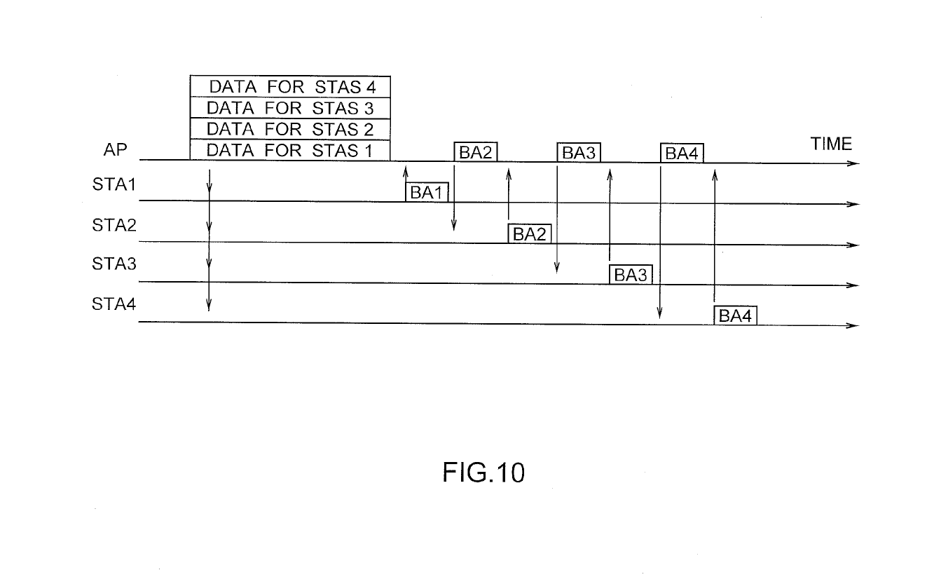

FIG. 9 are diagrams for illustrating notification fields, which illustrate an example of a configuration of the wireless communication system 3 according to the fourth embodiment. FIG. 10 is a time chart showing an example of an operation of the wireless communication system 3 according to the fourth embodiment.

Fields shown in FIGS. 9(A) and 9(B) are included in a frame body of the management frame, for example, and transmitted from the second wireless communication device 2 to each station. The fields shown in FIGS. 9(A) and 9(B) are fields already defined in IEEE 802.11ac. A field shown in FIG. 9C is a field added in this embodiment.

Since the field shown in FIG. 9C is added to the existing fields shown in FIGS. 9(A) and 9(B), the response scheme according to the existing IEEE 802.11ac standard (see FIG. 10) and the simultaneous response scheme according to this embodiment (see FIG. 3) can coexist.

FIG. 9 will be described in more detail. FIG. 9A shows to which group a station belongs. For example, if “1” is set in each of bit[1], bit[2] and bit[4] in FIG. 9A, it means that the station belongs to groups having group IDs of 1, 2 and 4.

FIG. 9B shows the user position of the station in each group to which the station belongs. For example, suppose that, in FIG. 9B, bit[3:2]=2′b10, bit[5:4]=2′b11, and bit[9:8]=2′b00. In this case, the user position for a group ID of 1 is “2”, the user position for a group ID of 2 is “3”, and the user position for a group ID of 4 is “0”.

FIG. 9C shows a response mode for each group to which the station belongs. If any station that belongs to a group supports only the existing response scheme complying with IEEE 802.11ac, the second wireless communication device 2 sets all the bits of the response mode that corresponds to the group at “0”.

If the bits of a response mode are “0”, it means that the existing response scheme shown in FIG. 10 is used as the response scheme of the response frame. The scheme shown in FIG. 10 is a scheme in which block acknowledgements are sequentially transmitted back.

On the other hand, if any station that belongs to a group supports only the simultaneous response scheme, the second wireless communication device 2 sets all the bits of the response mode that corresponds to the group at “1”.

If the bits of a response mode are “1”, it means that the simultaneous response scheme according to this embodiment shown in FIG. 3 is used as the response scheme of the response frame.

For example, in FIG. 9C, bit[1]=0, bit[2]=1, and bit[4]=1.

In this case, stations belonging to the group having a group ID of 1 use the existing response scheme complying with the IEEE 802.11ac standard. That is, any station that receives the first frame destined for the stations having a group ID of 1 including itself uses the scheme shown in FIG. 10 to transmit the response frame in response to the first frame.

On the other hand, stations belonging to groups having a group ID of 2 or 4 use the simultaneous response scheme according to this embodiment. That is, any station that receives the first frame destined for the stations having a group ID of 2 or 4 including itself uses the scheme shown in FIG. 3 to transmit the response frame.

According to this embodiment, by simply adding the response mode field to the existing fields, a station that supports only the existing response scheme complying with the IEEE 802.11ac standard and a station that supports the simultaneous response scheme according to this embodiment become able to coexist in the same network.

Furthermore, since the stations belonging to the same group share the same response mode information, simultaneous transmission of the response frame can be simply and appropriately achieved.

The remainder of the operation according to the fourth embodiment is the same as that according to the first embodiment. Therefore, the fourth embodiment further has the advantages of the first embodiment.

### Fifth Embodiment

Next, a fifth embodiment will be described. In the description of this embodiment, components corresponding to those in the first embodiment will be denoted by the same reference numerals, and redundant description thereof will be omitted.

According to this embodiment, the second wireless communication device 2 transmits a second frame to the first wireless communication devices 1. In addition, the second wireless communication device 2 measures the required time from the transmission of the second frame to the reception of a third frame, which is transmitted from each of the first wireless communication device 1 in response to the second frame, by the second wireless communication device 2. The second wireless communication device 2 assigns a same group ID to a plurality of first wireless communication devices 1 the difference in measured required time between which falls within a threshold.

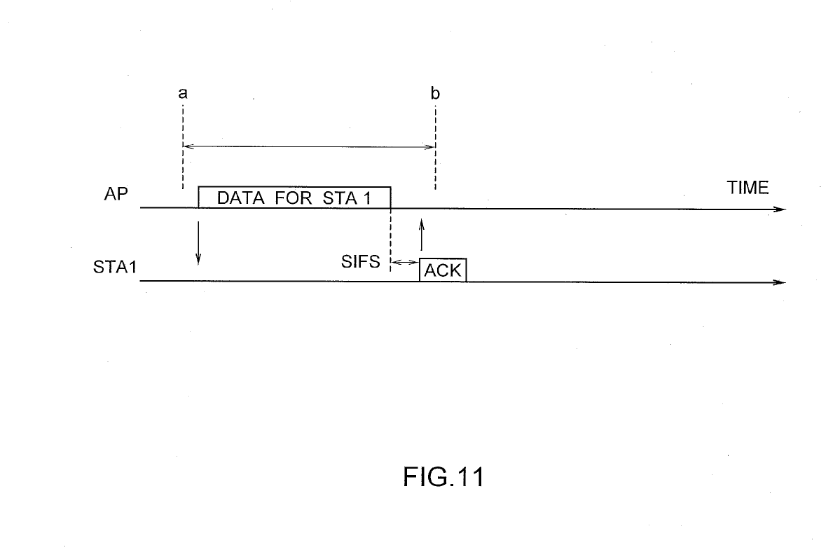

A specific example of this embodiment will be described below. FIG. 11 is a time chart showing an example of an operation of the wireless communication system 3 according to the fifth embodiment.

As shown in FIG. 11, an access point “AP”, that is, the second wireless communication device 2 transmits a data frame, which is an example of the second frame, to each station (only the station “STA1” is shown as a representative in FIG. 11). The access point “AP” measures the required time from the transmission of the data frame (the point in time “a” in FIG. 11) to the reception of an Ack frame from the station (the point in time “b” in FIG. 11). The Ack frame is an example of the third frame.

The access point “AP” may measure the required time a plurality of number of times by transmitting the data frame to each station a plurality of number of times and receiving the Ack frame from the station a plurality of number of times. In that case, the access point “AP” can average the plurality of required times obtained by the plurality of measurements and use the average value as the final measurement result.

The access point “AP” then assigns a same group ID to the stations the difference in required time between which falls within a threshold (100 ns, for example).

The point in time at which the access point “AP” transmits the data frame to the station (the point in time “a” in FIG. 11) may be the point in time at which the MAC layer part 15 requests the modulating part 16 to transmit the data frame or the point in time at which the modulating part 16 outputs the first data of the data frame to the DAC part 17.

The point in time at which the access point “AP” receives the Ack frame (the point in time “b” in FIG. 11) may be the point in time at which the demodulating part 12 notifies the MAC layer part 15 of the reception of the Ack frame, the point in time at which the ADC part 14 outputs the first data of the Ack frame to the demodulating part 12, or the point in time at which the ADC part 14 outputs the last data of the Ack frame to the demodulating part 12.

According to this embodiment, the same group ID can be assigned to a plurality of stations the difference in response speed of the third frame between which is small. Therefore, simultaneous transmission of the response frames can be simply achieved.

The remainder of the operation according to the fifth embodiment is the same as that according to the first embodiment. Therefore, the fifth embodiment further has the advantages of the first embodiment.

### Sixth Embodiment

Next, a sixth embodiment will be described. In the description of this embodiment, components corresponding to those in the first embodiment will be denoted by the same reference numerals, and redundant description thereof will be omitted.

According to this embodiment, the second wireless communication device 2 transmits the second frame to the first wireless communication devices 1. In addition, the second wireless communication device 2 measures the received power of the third frame transmitted from each of the first wireless communication devices 1 in response to the second frame. The second wireless communication device 2 assigns a same group ID to a plurality of first wireless communication devices 1 the difference in measured received power between which falls within a threshold. The threshold of the difference in received power may be 5 dB.

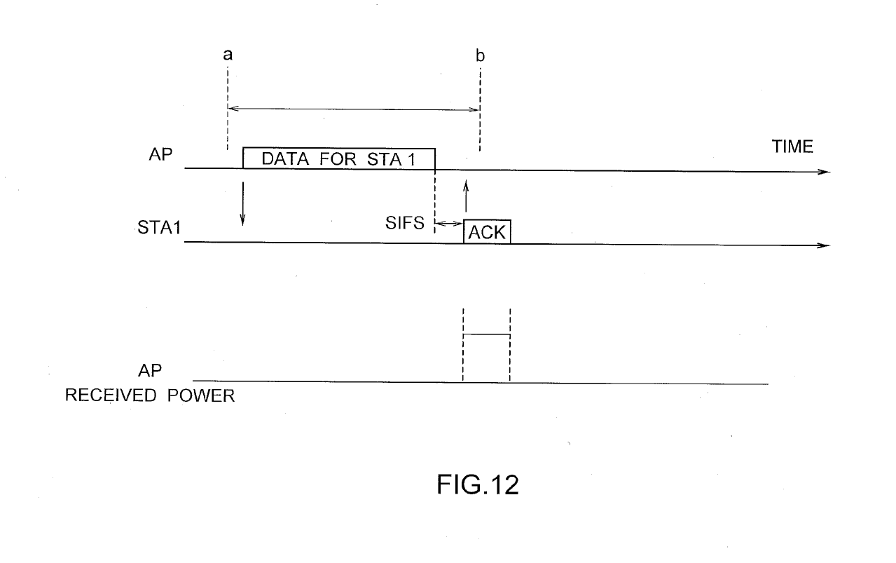

FIG. 12 is a time chart showing an example of an operation of the wireless communication system 3 according to the sixth embodiment.

As shown in FIG. 12, the second frame may be a data frame transmitted from the access point “AP” to a station, as in the fifth embodiment shown in FIG. 11. The third frame may be the Ack frame transmitted from a station to the access point “AP”, as in the fifth embodiment shown in FIG. 11. In FIG. 12, the received power of the Ack frame is measured as the received power of the third frame.

The access point “AP” may measure the received power a plurality of number of times by transmitting the data frame to each station a plurality of number of times and receiving the Ack frame from the station a plurality of number of times. In that case, the access point “AP” can average the plurality of received powers obtained by the plurality of measurements and use the average value as the final measurement result.

This embodiment can be combined with the fifth embodiment. In that case, the access point “AP” assigns a same group ID to a plurality of stations the difference in required time described in the fifth embodiment between which falls within a threshold and the difference in received power between which falls within a threshold.

According to this embodiment, the same group ID can be assigned to a plurality of stations the difference in reception sensitivity of the third frame between which is small. Therefore, simultaneous transmission of the response frames can be simply achieved.

The remainder of the operation according to the sixth embodiment is the same as that according to the first embodiment. Therefore, the sixth embodiment further has the advantages of the first embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A wireless communication device that performs wireless communication, comprising:
a wireless transmitting/receiving part that receives a first frame transmitted from a transmission source in which data destined for an address of the wireless communication device and data destined for an address of another wireless communication device are included;
a response channel selecting part that selects a response channel used for transmission of a response frame to the transmission source based on information included in the first frame received by the wireless transmitting/receiving part; and
an oscillating part that outputs a carrier signal having a frequency that corresponds to the response channel selected by the response channel selecting part to the wireless transmitting/receiving part,
wherein the response channel selecting part decides an ordinal rank for response channel selection based on the information included in the first frame and selects a response channel that corresponds to the decided ordinal rank, and
the wireless transmitting/receiving part uses the carrier signal output from the oscillating part to transmit the response frame in the response channel.

2. The wireless communication device according to claim 1, wherein the wireless transmitting/receiving part receives ordinal rank information that indicates a predetermined ordinal rank of the wireless communication device from the transmission source,
the first frame includes number-of-data information that indicates the number of pieces of data destined for the address of the wireless communication device and the number of pieces of data destined for the address of the another wireless communication device,
in the number-of-data information, the number of pieces of data for the wireless communication device is associated with the ordinal rank of the wireless communication device indicated by the ordinal rank information,
the response channel selecting part decides, as the ordinal rank for response channel selection, the ordinal rank of the wireless communication device indicated by the ordinal rank information advanced by the number of ordinal ranks with which no data is associated if the number-of-data information indicates that there is an ordinal rank with which no data is associated that is higher than the ordinal rank of the wireless communication device indicated by the ordinal rank information, and
the response channel selecting part decides, as the ordinal rank for response channel selection, the ordinal rank of the wireless communication device indicated by the ordinal rank information if the number-of-data information indicates that there is not any ordinal rank with which no data is associated that is higher than the ordinal rank of the wireless communication device indicated by the ordinal rank information.

3. The wireless communication device according to claim 1, wherein the first frame includes bandwidth information that indicates a bandwidth of the frame, and
the response channel selecting part obtains a comparison value for comparison with the ordinal rank for response channel selection based on the bandwidth information, compares the obtained comparison value with the ordinal rank for response channel selection, and selects the response channel if the comparison result shows that the comparison value is greater than the ordinal rank for response channel selection or does not select any response channel if the comparison result shows that the comparison value is smaller than the ordinal rank for response channel selection.

4. The wireless communication device according to claim 2, wherein the first frame includes bandwidth information that indicates a bandwidth of the frame, and
the response channel selecting part obtains a comparison value for comparison with the ordinal rank for response channel selection based on the bandwidth information, compares the obtained comparison value with the ordinal rank for response channel selection, and selects the response channel if the comparison result shows that the comparison value is greater than the ordinal rank for response channel selection or does not select any response channel if the comparison result shows that the comparison value is smaller than the ordinal rank for response channel selection.

5. The wireless communication device according to claim 3, wherein, when the response channel selecting part does not select any response channel, if the wireless transmitting/receiving part receives a request signal for transmission of the response frame, the response channel selecting part decides the ordinal rank for response channel selection based on information include in the request signal and selects the response channel that corresponds to the decided ordinal rank.

6. The wireless communication device according to claim 4, wherein, when the response channel selecting part does not select any response channel, if the wireless transmitting/receiving part receives a request signal for transmission of the response frame, the response channel selecting part decides the ordinal rank for response channel selection based on information include in the request signal and selects the response channel that corresponds to the decided ordinal rank.

7. The wireless communication device according to claim 1, wherein the first frame includes necessity information that indicates whether transmission of the response frame is necessary or not,
the response channel selecting part selects the response channel if the necessity information indicates that transmission of the response frame is necessary, and
the response channel selecting part does not select any response channel if the necessity information indicates that transmission of the response frame is not necessary.

8. The wireless communication device according to claim 2, wherein the first frame includes necessity information that indicates whether transmission of the response frame is necessary or not,
the response channel selecting part selects the response channel if the necessity information indicates that transmission of the response frame is necessary, and
the response channel selecting part does not select any response channel if the necessity information indicates that transmission of the response frame is not necessary.

9. The wireless communication device according to claim 3, wherein the first frame includes necessity information that indicates whether transmission of the response frame is necessary or not,
the response channel selecting part selects the response channel if the necessity information indicates that transmission of the response frame is necessary, and
the response channel selecting part does not select any response channel if the necessity information indicates that transmission of the response frame is not necessary.

10. The wireless communication device according to claim 4, wherein the first frame includes necessity information that indicates whether transmission of the response frame is necessary or not,
the response channel selecting part selects the response channel if the necessity information indicates that transmission of the response frame is necessary, and
the response channel selecting part does not select any response channel if the necessity information indicates that transmission of the response frame is not necessary.

11. The wireless communication device according to claim 5, wherein the first frame includes necessity information that indicates whether transmission of the response frame is necessary or not,
the response channel selecting part selects the response channel if the necessity information indicates that transmission of the response frame is necessary, and
the response channel selecting part does not select any response channel if the necessity information indicates that transmission of the response frame is not necessary.

12. The wireless communication device according to claim 6, wherein the first frame includes necessity information that indicates whether transmission of the response frame is necessary or not,
the response channel selecting part selects the response channel if the necessity information indicates that transmission of the response frame is necessary, and
the response channel selecting part does not select any response channel if the necessity information indicates that transmission of the response frame is not necessary.

13. The wireless communication device according to claim 1, wherein the first frame includes necessity information that indicates whether transmission of the response frame is necessary or not, and
the response channel selecting part selects a frequency channel in which the first frame is received instead of the response channel if the response channel selecting part detects that transmission of the response frame is not necessary based on the necessity information after selecting the response channel.

14. The wireless communication device according to claim 2, wherein the first frame includes necessity information that indicates whether transmission of the response frame is necessary or not, and
the response channel selecting part selects a frequency channel in which the first frame is received instead of the response channel if the response channel selecting part detects that transmission of the response frame is not necessary based on the necessity information after selecting the response channel.

15. The wireless communication device according to claim 3, wherein the first frame includes necessity information that indicates whether transmission of the response frame is necessary or not, and
the response channel selecting part selects a frequency channel in which the first frame is received instead of the response channel if the response channel selecting part detects that transmission of the response frame is not necessary based on the necessity information after selecting the response channel.

16. The wireless communication device according to claim 1, wherein the wireless communication is wireless communication in a wireless LAN communication scheme that complies with IEEE 802.11.

17. A wireless communication system in which a plurality of first wireless communication devices and a second wireless communication device perform wireless communication with each other, the second wireless communication device transmitting, to the plurality of first wireless communication devices, a first frame in which data destined for addresses of the first wireless communication devices are included,
wherein the first wireless communication devices comprise:
a wireless transmitting/receiving part that receives the first frame transmitted from the second wireless communication device;
a response channel selecting part that selects a response channel used for transmission of a response frame to the second wireless communication device based on information included in the first frame received by the wireless transmitting/receiving part; and
an oscillating part that outputs a carrier signal having a frequency that corresponds to the response channel selected by the response channel selecting part to the wireless transmitting/receiving part,
the response channel selecting part decides an ordinal rank for response channel selection based on the information included in the first frame and selects a response channel that corresponds to the decided ordinal rank, and
the wireless transmitting/receiving part uses the carrier signal output from the oscillating part to transmit the response frame in the response channel.

18. The wireless communication system according to claim 17, wherein the first frame is a frame in which data destined for addresses of a plurality of first wireless communication devices to which a same group ID is assigned are spatially multiplexed,
the first frame includes response mode information that indicates a response scheme of the response frame,
the response mode information is associated with the group ID, and
the response mode information associated with the same group ID shares a common response scheme.

19. The wireless communication system according to claim 18, wherein the second wireless communication device transmits a second frame to the first wireless communication devices, measures a required time from transmission of the second frame to reception, by the second wireless communication device, of a third frame transmitted by the first wireless communication devices in response to the second frame, and assigns the same group ID to a plurality of first wireless communication devices the difference in measured required time between which falls within a threshold.

20. The wireless communication system according to claim 18, wherein the second wireless communication device transmits a second frame to the first wireless communication devices, measures a received power of a third frame at the second wireless communication device, the third frame being transmitted by the first wireless communication devices in response to transmission of the second frame, and assigns the same group ID to a plurality of first wireless communication devices the difference in measured received power between which falls within a threshold.
